(19) United States
(12) Patent Application Publication
(10) Pub. No.: US 2025/0219561 A1
(43) Pub. Date: Jul. 3, 2025

(54) MOTOR CONTROL DEVICE AND VEHICLE BRAKE DEVICE

(71) Applicant: DENSO CORPORATION, Kariya-city (JP)

(72) Inventors: YUSUKE SHIBATA, Kariya-city (JP); TOMOHIKO TSURUTA, Nisshin-city (JP)

(21) Appl. No.: 19/079,117

(22) Filed: Mar. 13, 2025

Related U.S. Application Data
(63) Continuation of application No. PCT/JP2023/030642, filed on Aug. 25, 2023.

(30) Foreign Application Priority Data
Sep. 16, 2022 (JP) 2022-148229

(51) Int. Cl. H02P 21/36; B60T 8/32; B60T 13/74; F16D 65/18; F16D 65/38; F16D 121/24; H02P 21/20; H02P 21/22

(52) U.S. Cl. CPC H02P 21/36; B60T 8/321; B60T 13/746; F16D 65/18; F16D 65/38; H02P 21/20; H02P 21/22; B60T 2250/04; F16D 2065/386; F16D 2121/24

(57) ABSTRACT

A motor control device includes a torque command calculation unit that calculates a torque command value, a current command calculation unit that calculates a current command value, a power converter, and a stop position adjuster. The stop position adjuster executes a stop position adjustment process that adjusts the rotation stop position within a specified position adjustment range when a lock current is applied while the rotation of the multiphase motor is stopped, except in cases where specified exemption requirement is met. In the stop position adjustment process, the stop position adjuster adjusts the rotation stop position so as to bias the current to one or more high heat dissipation phases having a relatively high heat dissipation property among the phases. The torque command calculation unit or the current command calculation unit calculates a torque command value or a current command value reflecting an adjusted rotation stop position.

### CROSS REFERENCE TO RELATED APPLICATIONS

This application is a continuation application of International Patent Application No. PCT/JP2023/030642 filed on Aug. 25, 2023, which designated the U.S. and based on and claims the benefits of priority of Japanese Patent Application No. 2022-148229 filed on Sep. 16, 2022. The entire disclosure of all of the above applications is incorporated herein by reference.

### TECHNICAL FIELD

The present disclosure relates to a motor control device and a vehicle brake device.

### BACKGROUND

Conventionally, a motor control device that controls a current to energize a multiphase motor are known. Further, an electric motor for a vehicle is known that converts torque output by a multiphase motor into linear force by a linear motion mechanism and presses the linear force against a corresponding wheel to generate a braking force.

### SUMMARY

An object of the present disclosure is to provide a motor control device that prevents heat generation from being concentrated in a specific phase when a lock current is applied to the multiphase motor. Another object of the present disclosure is to provide a vehicle brake device including a plurality of motor control devices for achieving the above object, which control the energization of the multiphase motor constituting an electric brake for each wheel.

A motor control device of the present disclosure includes a torque command calculation unit, a current command calculation unit, a power converter, and a stop position adjuster. The torque command calculation unit calculates a torque command value for a multiphase motor. The current command calculation unit calculates a current command value for supplying current to the multiphase motor based on the torque command value. The power converter converts input power and supplies AC power corresponding to the current command value to the multiphase motor.

The stop position adjuster executes a stop position adjustment process that adjusts the rotation stop position within a specified position adjustment range when a lock current is applied while the rotation of the multiphase motor is stopped, except in cases where specified exemption requirement is met.

In the stop position adjustment process, the stop position adjuster adjusts the rotation stop position so as to bias the current to one or more high heat dissipation phases having a relatively high heat dissipation property among the phases. The torque command calculation unit or the current command calculation unit calculates a torque command value or a current command value that reflects an adjusted rotation stop position.

A vehicle brake device of the present disclosure is mounted on a vehicle having four or more wheels including two or more rows of left and right wheels in a front-rear direction. The vehicle brake device converts torque output by a multiphase motor into linear force by a linear motion mechanism, and applies brakes to the vehicle using a plurality of electric brakes that press against corresponding wheels to generate braking forces.

The vehicle brake device includes the motor control device described above that controls energization of the multiphase motors in the electric brakes, and mediates the stop position adjustment processes performed by the multiple motor control devices.

### BRIEF DESCRIPTION OF THE DRAWINGS

The above and other objects, features and advantages of the present disclosure will become more apparent from the following detailed description taken in conjunction with the accompanying drawings. In the drawings:

FIG. 1 is a configuration diagram showing a motor control device for a motor for an electric brake of a vehicle;

FIG. 2 is a schematic diagram of an electric brake for each wheel;

FIG. 3A is a schematic diagram of an electric brake pad;

FIG. 3B is a characteristic diagram of a pad load and a pad position;

FIG. 4 is a diagram showing hysteresis characteristics of a motor torque and a braking force;

FIG. 5 is a block diagram illustrating a configuration example of a motor controller according to a first embodiment;

FIG. 6 is a diagram showing a stop position relative to a required load in a comparative example;

FIG. 7 is a three-phase current waveform diagram showing an example of a lock current application position in a comparative example;

FIG. 8 is a diagram showing a stop position with respect to a required load in the present embodiment;

FIG. 9 is a three-phase current waveform diagram showing an example of a lock current application position in the present embodiment;

FIG. 10 is a diagram comparing a relationship between a high current phase and a high heat dissipation phase when locking current is applied before and after the adjustment of the stop position;

FIG. 11 is a diagram showing a first example of heat dissipation bias in a three-slot three-phase motor;

FIG. 12A is a diagram showing a second example of heat dissipation bias in a three-slot three-phase motor;

FIG. 12B is a diagram showing the second example of heat dissipation bias in a three-slot three-phase motor;

FIG. 13A is a diagram showing a third example of heat dissipation bias in a three-slot three-phase motor;

FIG. 13B is a diagram showing the third example of heat dissipation bias in a three-slot three-phase motor;

FIG. 14 is a diagram showing a fourth example of heat dissipation bias in a three-slot three-phase motor;

FIG. 15 is a diagram showing a fifth example of heat dissipation bias in a three-slot three-phase motor;

FIG. 16 is a diagram for explaining an example of a stop position adjustment process when a high heat dissipation phase is one phase;

FIG. 17 is a diagram for explaining an example of a stop position adjustment process when there are two high heat dissipation phases;

FIG. 18 is a flowchart of a stop position adjustment process;

FIG. 19 is a flowchart of determination of whether an exemption condition is satisfied;

FIG. 20 is a flowchart of mediating for a stop position adjustment process performed by a vehicle brake device; and

FIG. 21 is a block diagram illustrating an example of the configuration of a motor control device according to a second embodiment.

### DETAILED DESCRIPTION

In an assumable example, a motor control device that controls a current to energize a multiphase motor are known. Further, an electric motor for a vehicle is known that converts torque output by a multiphase motor into linear force by a linear motion mechanism and presses the linear force against a corresponding wheel to generate a braking force. For example, in the electric brake device, a motor control device controls a drive current of the motor based on the magnitude of the pressing force detected by a load sensor. A relationship between a motor torque and the pressing force has a hysteresis characteristic. When the pressing force is applied to and maintained on the brake disc, this motor control device increases the motor torque along a positive efficiency line until the pressing force rises to a predetermined value greater than a target value, and then decreases the motor torque along an inverse efficiency line until the pressing force decreases to the target value.

According to the related example, a current may be reduced by: generating the braking force slightly higher than target braking force and then reducing the current while maintaining the braking force; and operating the inverse efficiency line to reduce the braking force to the target braking force. However, in order to maintain the braking force, it is necessary to apply an electric current to lock the brake. When the actuator of the electric brake is provided with a multiphase motor, the current may be concentrated on a specific phase and causes uneven heating. The above situation is not only limited to an electric brake, but may also be common to the multiphase motor that may have lock current application.

An object of the present disclosure is to provide a motor control device that prevents heat generation from being concentrated in a specific phase when a lock current is applied to the multiphase motor. Another object of the present disclosure is to provide a vehicle brake device including a plurality of motor control devices for achieving the above object, which control the energization of the multiphase motor constituting an electric brake for each wheel.

A motor control device of the present disclosure includes a torque command calculation unit, a current command calculation unit, a power converter, and a stop position adjuster. The torque command calculation unit calculates a torque command value for a multiphase motor. The current command calculation unit calculates a current command value for supplying current to the multiphase motor based on the torque command value. The power converter converts input power and supplies AC power corresponding to the current command value to the multiphase motor.

The stop position adjuster executes a stop position adjustment process that adjusts the rotation stop position within a specified position adjustment range when a lock current is applied while the rotation of the multiphase motor is stopped, except in cases where specified exemption requirement is met.

In the stop position adjustment process, the stop position adjuster adjusts the rotation stop position so as to bias the current to one or more high heat dissipation phases having a relatively high heat dissipation property among the phases. The torque command calculation unit or the current command calculation unit calculates a torque command value or a current command value that reflects an adjusted rotation stop position.

As a result, in the present disclosure, it is possible to prevent heat generation from being concentrated in a specific phase when locking current is applied to the multiphase motor. Preferably, when the high heat dissipation phase is one phase, in the stop position adjustment process, the rotation stop position of the multiphase motor is adjusted to a position where the current absolute value of the high heat dissipation phase is maximum within a position adjustment range.

A vehicle brake device of the present disclosure is mounted on a vehicle having four or more wheels including two or more rows of left and right wheels in a front-rear direction. The vehicle brake device converts torque output by a multiphase motor into linear force by a linear motion mechanism, and applies brakes to the vehicle using a plurality of electric brakes that press against corresponding wheels to generate braking forces.

The vehicle brake device includes the motor control device described above that controls energization of the multiphase motors in the electric brakes, and mediates the stop position adjustment processes performed by the multiple motor control devices. This makes it possible to prevent the occurrence of yaw or spin, and minimize the change in actual braking force relative to the required braking force for the entire vehicle.

An embodiment of a motor control device and a vehicle brake device according to the present disclosure will be described with reference to the drawings. The following first and second embodiments are collectively referred to as “the present embodiment”. The motor controller according to this embodiment is adapted to a vehicle and controls the energization of a three-phase motor used for electric brakes on each wheel. The vehicle brake device includes a motor control device that controls energization of a three-phase motor serving as a “multiphase motor” in each electric brake, and mediates a process performed by the multiple motor control devices, which will be described later.

### Vehicle Configuration

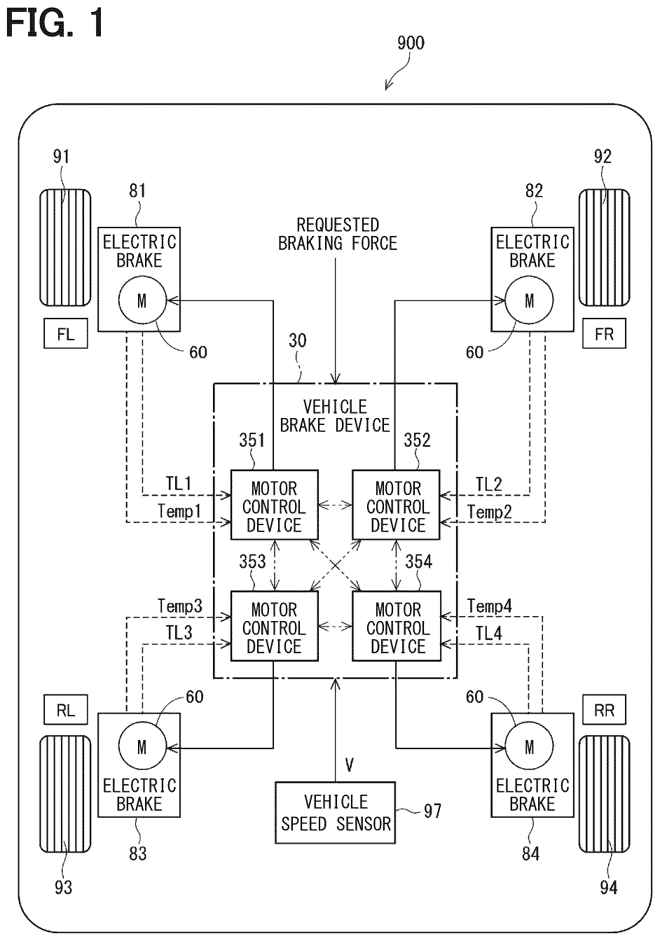

The configurations of a vehicle 900 on which the brake device 30 for the vehicle of the present embodiment is mounted and electric brakes 81 to 84 will be described with reference to FIGS. 1 to 3B. As shown in FIG. 1, the vehicle 900 is a four-wheel vehicle having two rows of left and right pairs of wheels 91, 92, 93, 94 in a front-rear direction. The left and right wheels 91, 92 at the front row may also be noted as “FL” and “FR”, respectively. The left and right wheels 93, 94 at the rear row may also be noted as “RL” and “RR”, respectively. The electric brakes 81, 82, 83, 84 are provided for the respective wheels 91, 92, 93, 94. In other words, four electric brakes are provided in this example.

The vehicle brake device 30 includes four motor control devices 351, 352, 353, and 354 that control the energization of the three-phase motor 60 in each of the electric brakes 81, 82, 83, and 84. Hereinafter, four consecutive reference numbers will be abbreviated, such as “wheels 91 to 94,” “electric brakes 81 to 84,” and “motor control devices 351 to 354.” The same applies to the symbols “force torques TL1 to TL4” and “motor temperatures Temp1 to Temp4” described below. In addition, the vehicle brake device 30 acquires a vehicle speed V from a vehicle speed sensor 97.

Each of the actuators of the electric brakes 81 to 84 include a three-phase motor 60 as a “multiphase motor.” The three-phase motor 60 according to the present embodiment is a permanent magnet-type brushless motor. In the present embodiment, the three-phase motors 60 corresponding to the electric brakes 81 to 84 have the same configuration and function. Therefore, a single reference numeral “60” is used. In the following description, the three-phase motor 60 will be abbreviated as simply “motor 60” where appropriate.

The motor control devices 351 to 354 control the braking forces generated by the electric brakes 81 to 84 based on the required braking forces commanded from the outside. The required braking force is commanded by the driver's brake operation, a braking signal from a driving support device, or the like. As indicated by the dashed double-headed arrows, each of the motor control devices 351 to 354 may communicate information with each other.

The four motor control devices 351 to 354 are not necessarily physically separate, and may be integrated onto a single board. Specifically, the ECU included in the vehicle brake device 30 functions as the motor control device 351 to 354. The ECU includes, for example, a microcomputer, a pre-driver, and the like, and has a CPU, a ROM, a RAM, an I/O, and a bus line (not shown) connecting these components. The ECU performs required control by executing software processing or hardware processing. The software processing may be implemented by causing the CPU to execute a program. The program may be stored beforehand in a memory device such as a ROM, that is, in a readable non-transitory tangible storage medium. The hardware processing may be implemented by a special purpose electronic circuit.

The motor control devices 351 to 354 may acquire the force torques TL1 to TL4 or the motor temperatures Temp1 to Temp4. The force torques TL1 to TL4 may be estimated from the power consumption of the inverter. The motor temperatures Temp1 to Temp4 are detected by, for example, a temperature sensor. Alternatively, the motor temperatures Temp1 to Temp4 may be calculated by estimating a temperature rise from Joule heat caused by energizing the three-phase motor 60 and adding the estimated temperature rise to the outside air temperature. The force torques TL1 to TL4 and the motor temperatures Temp1 to Temp4 will be described later in the explanation of exemption. If not used to determine whether or not the exemption requirement is met, the motor control devices 351 to 354 do not need to acquire the force torques TL1 to TL4 or the motor temperatures Temp1 to Temp4.

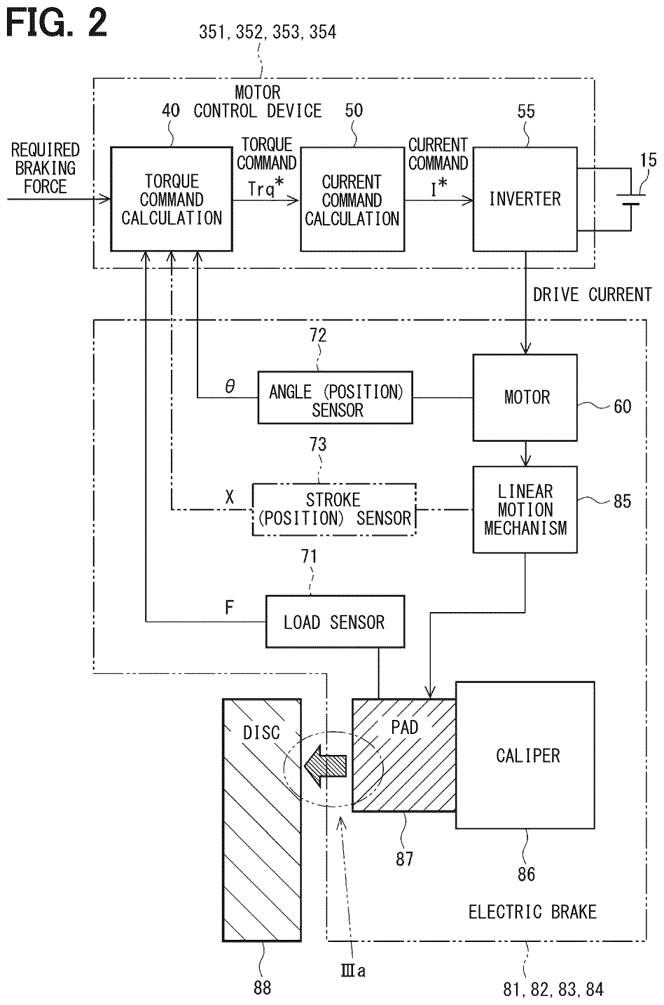

In the present embodiment, the control configurations of the electric brakes 81 to 84 are the same. FIG. 2 illustrates the control configuration of the electric brakes by the motor control devices 351 to 354, taking one of the electric brakes 81 to 84 as an example.

Each of the electric brakes 81 to 84 includes a motor 60, a linear motion mechanism 85, and a caliper 86. The motor 60 is, for example, a permanent magnet type three-phase brushless motor, and outputs torque in response to a drive current supplied from the braking force control unit 400. The linear motion mechanism 85 is an actuator that converts the output rotation of the motor 60 into linear motion while decelerating the output rotation. The rotation angle 0 of the motor 60 and the stroke X of the linear motion mechanism 85 are proportional to each other. In this manner, each of the electric brakes 81 to 84 converts the torque output by the motor 60 into linear force by the linear motion mechanism 85, and generates a braking force to press against the corresponding wheel 91 to 94.

The output torque of the motor 60 operates the pad 87 of the caliper 86 via the linear motion mechanism 85. The pad 87 moves and presses against the disks 88 of each wheel 91 to 94 to generate a braking force through friction. Furthermore, the pad 87 separates from the disk 88, and the braking force is released.

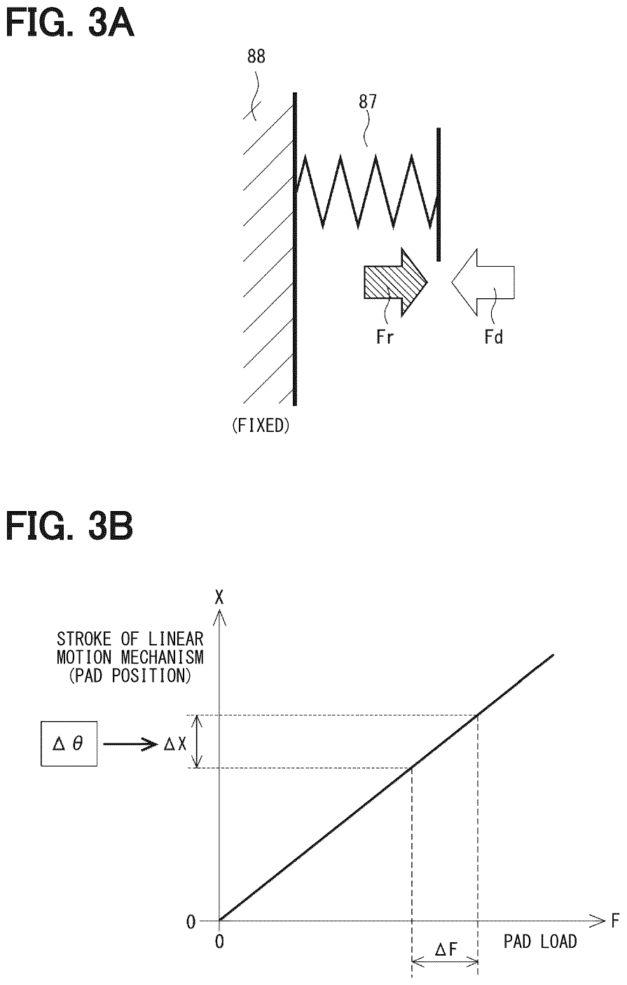

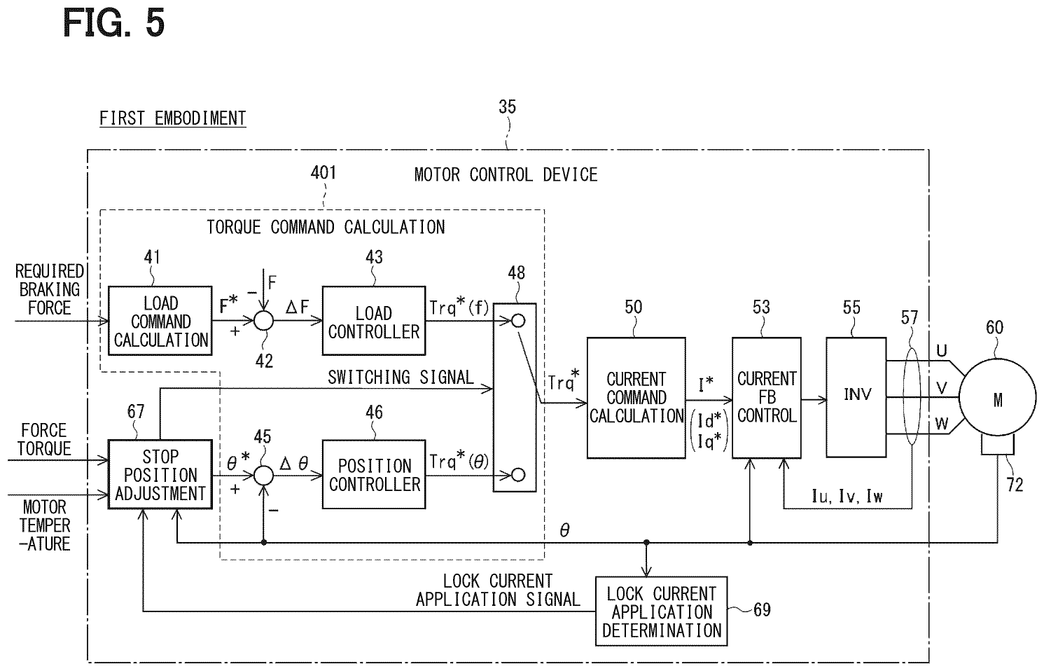

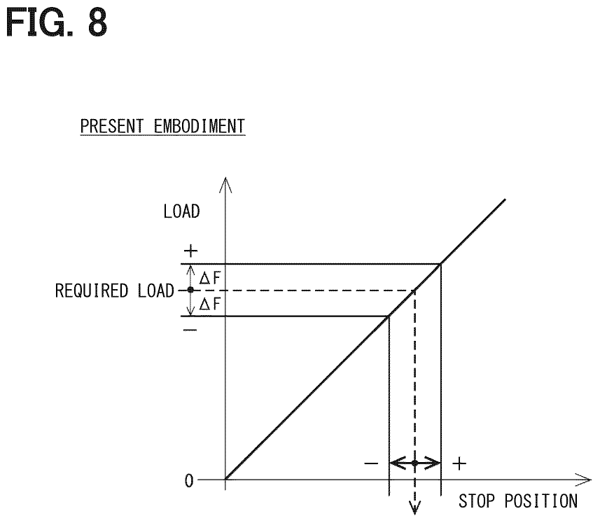

With reference to FIGS. 3A and 3B, the characteristics of the pad 87 of the electric brakes 81 to 81 shown in a portion IIIa of FIG. 2 will be supplemented. As shown in FIG. 3A, the pad 87 has spring-like characteristics, and a pressing force Fd by the linear motion mechanism 85 and a reaction force Fr according to the amount of deformation act in opposite directions. As shown in FIG. 3B, a pad position X based on the stroke of the linear motion mechanism 85 and a pad load F are approximately proportional. When the pad position changes by ΔX due to a change Δθ in the rotation angle of the motor 60, the pad load changes by ΔF. In addition, in FIG. 3B and FIG. 8, the symbol “ΔF” indicates a change in load. This “ΔF” used in FIG. 3B and FIG. 8 has a different meaning from “ΔF” used in FIG. 5, which indicates the load deviation between the load command value and the actual load in the load control.

Returning to FIG. 2, the motor control devices 351 to 354 each include a torque command calculation unit 40, a current command calculation unit 50, and an inverter 55. The torque command calculation unit 40 calculates a torque command value Trq* of the motor 60 based on a required braking force commanded from an external source. The current command calculation unit 50 calculates a current command value I* to be supplied to the motor 60 based on the torque command value.

The inverter 55 converts the input DC power of the battery 15 into AC power, and supplies the AC power according to the current command value I* to the motor 60. The configuration of the current feedback from the current command calculation unit 50 to the inverter 55 and the stop position adjuster specific to the present embodiment will be described later with reference to FIG. 5.

In addition, the electric brakes 81 to 84 are equipped with at least one of an angle sensor 72 and a stroke sensor 73. The angle sensor 72 detects an actual angle θ, which is an actual rotation angle of the motor 60. In the present embodiment, the actual angle θ is defined as a motor electrical angle. The stroke sensor 73 detects an actual stroke X, which is the actual stroke of the linear motion mechanism 85. The stroke sensor 73 may detect a change in the position of a moving part of the linear motion mechanism 85 or may detect a change in the position of the pad 87.

The angle sensor 72 and the stroke sensor 73 are collectively referred to as a “position sensor.” The position sensors 72, 73 are formed of, for example, a Hall element or a magnetic resistance element, and are capable of detecting the position with a relatively high degree of accuracy. Moreover, the actual angle θ and the actual stroke X are collectively referred to as an “actual position.” The actual positions θ, X detected by the position sensors 72, 73 are input to the torque command calculation unit 40. In the present embodiment, a configuration mainly including an angle sensor 72 is assumed, and in the following description, only the symbols “position sensor 72” and “actual position θ” are used. The configuration including the stroke sensor 73 will be described in other embodiments.

In the first embodiment, the electric brakes 81 to 84 further include a load sensor 71. The load sensor 71 detects an actual load F which is the braking load actually applied to the wheels 91 to 94. The actual load F detected by the load sensor 71 is input to the torque command calculation unit 40. In a second embodiment, the electric brakes 81 to 84 do not include the load sensor 71 in the first place, or the actual load F detected by the load sensor 71 is not used for the calculation by the torque command calculation unit 40.

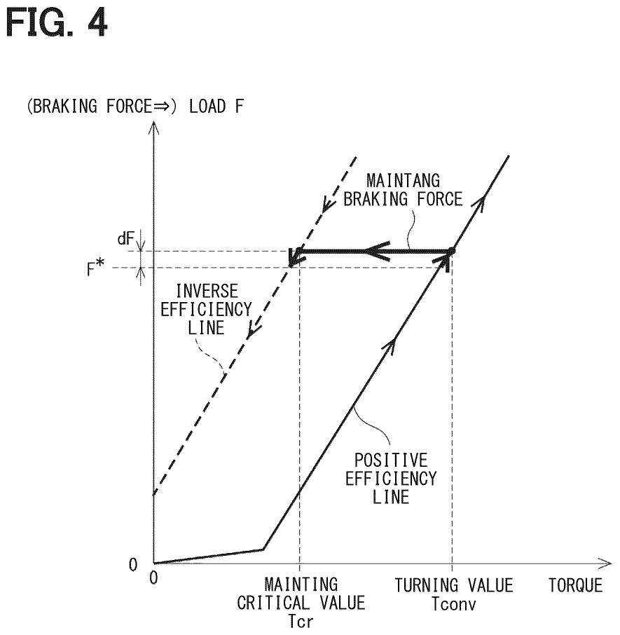

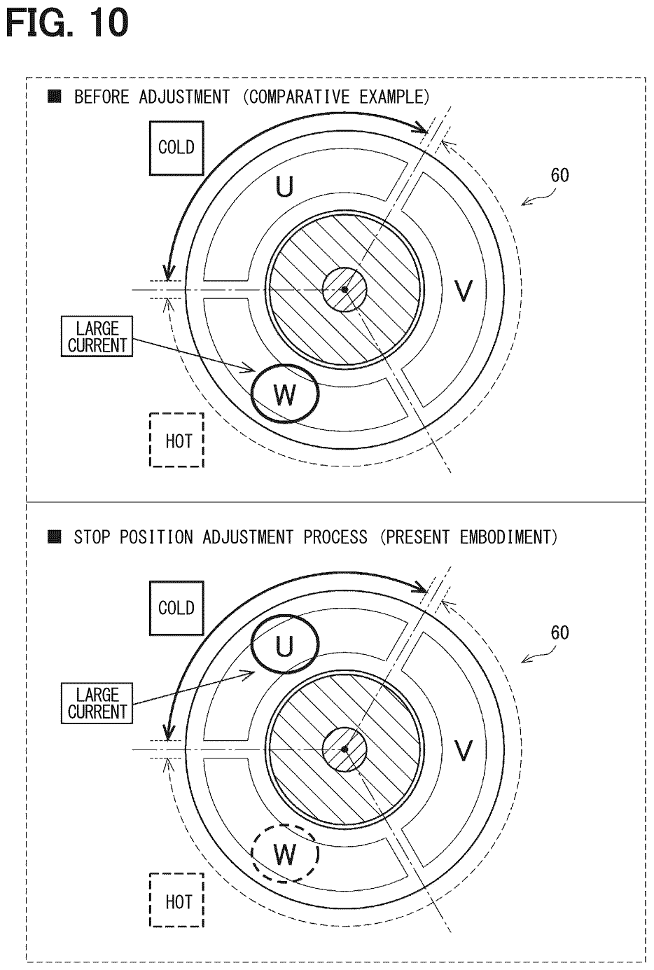

Next, the relationship between the motor torque and the braking force in the electric brake having this configuration will be described with reference to FIG. 4. The braking force is related to the brake pad load. Hereinafter, the term “torque” simply means the torque output by the motor 60, and the term “load” simply means the pressure load applied by the pad 87. FIG. 4 corresponds to FIG. 10 of Patent Document 1 (Japanese Patent No. 6080682).

A relationship between the torque of the motor 60 and the braking forces generated in the electric brakes 81 to 84 has a hysteresis characteristic. When the torque increases, the braking force increases along the positive efficiency line. When the torque decreases from a turning value Tconv, where the torque changes from increasing to decreasing, to a maintaining critical value Tcr, the braking force is maintained constant. When the torque decreases from the maintaining critical value Tcr, the braking force decreases along the inverse efficiency line. Here, the torque correlates with the drive current of the motor 60.

In the conventional technology of Patent Document 1, the torque of the motor is increased until the magnitude of the load detected by the load sensor reaches “a value that is greater than the target value F* by a predetermined offset value dF”. Thereafter, the drive current of the motor is controlled so as to reduce the motor torque until the magnitude of the load detected by the load sensor reaches the target value F*. The load F is maintained during the process of reducing the torque of the motor. This makes it possible to reduce the current while the braking force is being maintained.

However, when the actuator of an electric brake is composed of a multiphase motor, in the process of maintaining braking force, a “lock current application” is required in which current is flowed while the motor is stopped, which causes the current to concentrate in a specific phase, resulting in uneven heating. As a result, this can lead to breakdowns in inverter elements and motor windings, and can also require the use of highly heat-resistant components. Therefore, the motor control devices 351 to 354 of the present embodiment aim to prevent heat generation concentrated in a specific phase when lock current is applied to the three-phase motor 60, which occurs when the electric brakes 81 to 84 perform a braking force holding operation.

Next, a detailed configuration of each embodiment will be described. The motor control devices of the first and second embodiments only differ in the control configuration of the portion that switches between execution and non-execution of the stop position adjustment process, and have the same functions and effects. Regarding the reference numerals of the torque command calculation unit including the switching portion for switching between execution and non-execution of the stop position adjustment process, the torque command calculation unit of the first embodiment is given the reference numeral “401”, and the torque command calculation unit of the second embodiment is given the reference numeral “402” to distinguish them.

### First Embodiment

The first embodiment will be described with reference to FIGS. 5 to 20. In the first embodiment, when the stop position adjustment process is executed, a position control is performed to make the actual position θ follow the position command value θ*, and when the stop position adjustment process is not executed, a load control is performed to make the actual load F follow the load command value F*. The load control is executed in the process in which the braking force increases along the positive efficiency line and in the process in which the braking force decreases along the inverse efficiency line. In the process of reducing the torque while maintaining the braking force, the stop position adjustment process is executed by a position control as necessary. The adjustment amount of the stop position adjustment process may be set to zero, thereby substantially stopping the execution of the stop position adjustment process.

FIG. 5 shows a block diagram of the motor control device of the first embodiment. Each of the motor control devices 351 to 354 is collectively referred to as “35”. The torque command calculation unit 401 has a load command calculation unit 41, a load deviation calculator 42, a load controller 43, a position deviation calculator 45, a position controller 46, and a switch 48.

The load command calculation unit 41 calculates a load command value F* based on the required braking force. The load deviation calculator 42 calculates a load deviation ΔF(=F*−F) between the actual load F detected by the load sensor 71 and the load command value F*. The load controller 43 calculates the torque command value Trq*(f) so as to bring the load deviation ΔF closer to zero, that is, so as to bring the actual load F closer to the load command value F*.

The position deviation calculator 45 calculates a position deviation Δθ(=θ*−θ) between the actual position θ detected by the position sensor 72 and the position command value θ* output by the stop position adjuster 67. The position controller 46 calculates the torque command value Trq*(θ) so as to bring the position deviation Δθ closer to zero, that is, so as to bring the actual position θ closer to the position command value θ*.

The switch 48 switches between Trq*(f) and Trq*(θ) as the torque command value Trq* output by the torque command calculation unit 401 in accordance with a switching signal from the stop position adjuster 67. In the configuration example shown in FIG. 5, the switch 48 is provided on the output side of each controller 43, 46, but this switching function is not limited to this configuration, and a switching function may be realized, for example, to mask the operation of one of the load controller 43 or the position controller 46.

Further, the motor control device 35 includes, in addition to the current command calculation unit 50 and the inverter (“INV” in the FIG. 55, a current feedback control unit 53, a lock current application determination unit 69, and a stop position adjuster 67, which are omitted in FIG. 2.

The current command calculation unit 50 calculates the current command value I*, specifically, d-axis and q-axis current command values Id* and Iq* by a vector control, and outputs them to the current feedback control unit 53. The current feedback control unit 53 acquires the three-phase currents Iu, Iv, Iw detected by the current sensor 57 and the motor electrical angle, i.e., the actual position θ, detected by the position sensor 72, and converts the three-phase currents Iu, Iv, Iw into the d-axis and q-axis currents Id, Iq. The current feedback control unit 53 calculates a voltage command value so that the d-axis and q-axis currents Id, Iq follow the current command values Id*, Iq*, and further generates a switching signal by PWM control or the like and outputs it to the inverter 55.

The lock current application determination unit 69 determines whether or not it is “lock current application”, in which current is applied while the rotation of the motor 60 is stopped, based on the fluctuation range and time derivative of the actual position θ, and outputs a lock current application signal to the stop position adjuster 67 when it determines that it is lock current application. In addition, “stop” in the rotation includes a very low rotation speed state of, for example, about a few rotations per minutes (rpm).

The stop position adjuster 67 obtains the force torques TL1 to TL4 and the motor temperatures Temp1 to Temp4 from the corresponding electric brakes 81 to 84, and determines whether or not the exemption requirement described below is met. The stop position adjuster 67 executes a “stop position adjustment process” that adjusts the rotation stop position within a predetermined position adjustment range when the lock current is applied, except when the exemption requirement is met. In the following description, “stop position” means a rotation stop position.

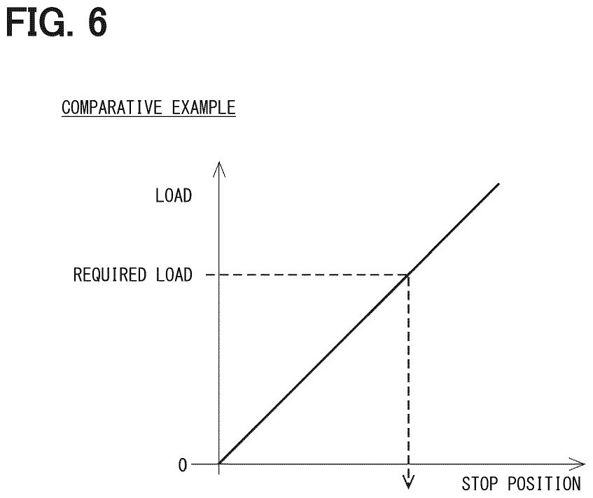

The motor control device 35 of the present embodiment is applied to a system in which the load acting on the force changes depending on the rotation stop position of the motor 60 when the lock current is applied to the motor. Next, the technical significance of the stop position adjustment process will be described with reference to FIGS. 6 to 10, in comparison with a comparative example in which the stop position adjustment process is not executed when the lock current is applied.

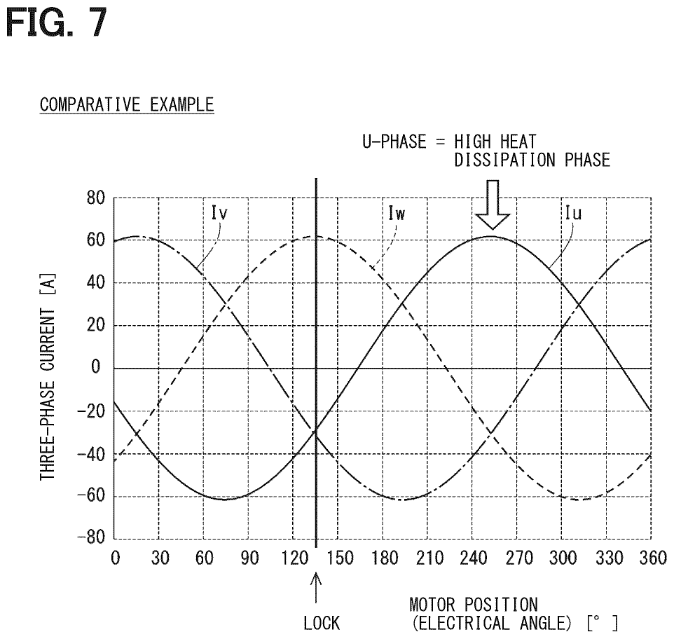

FIGS. 6 and 7 show examples of stop positions and lock current application positions with respect to a required load in a comparative example. In the comparative example, when a required load is determined, the stop position is uniquely determined, and there is a possibility that the motor will stop at a position where current is concentrated in a specific phase. Among the phases, a phase having a relatively high heat dissipation property is defined as a “high heat dissipation phase.” In the example of FIG. 7, it is assumed that when the U-phase is a high heat dissipation phase, the lock current is applied at a position (electrical angle 135° position) where the absolute value of the W-phase current Iw is maximum.

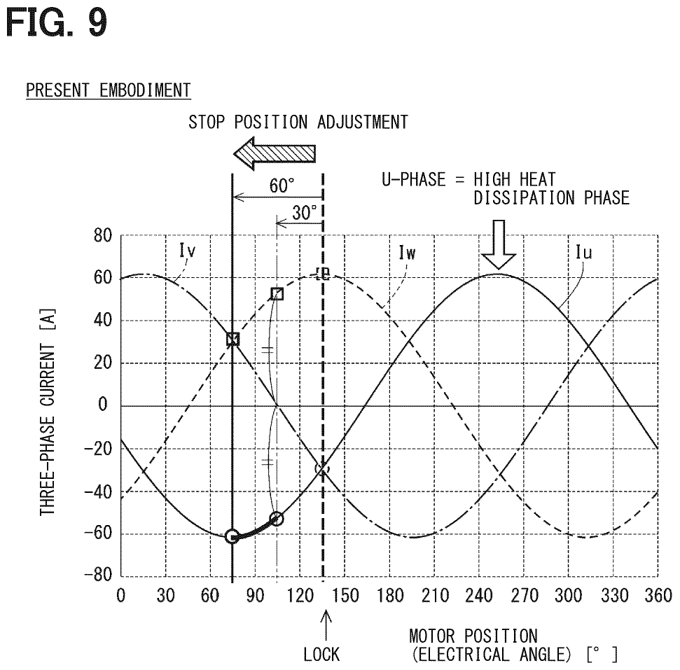

FIGS. 8 and 9 show examples of stop positions and lock current application positions with respect to a required load in the present embodiment. In the stop position adjustment process, the rotation stop position of the motor 60 is adjusted to a range corresponding to the allowable fluctuation range of the required load. In FIG. 8, the change in load due to the position adjustment is represented as ΔF. The position adjustment direction is defined, for example, as a positive direction on the side where the load increases and a negative direction on the side where the load decreases. FIG. 8 shows that the adjustment of the position θ and the adjustment of the load F are correlated with each other. In the example of FIG. 9, the stop position is adjusted by an electrical angle of 60° from the position of 135° electrical angle before adjustment to the position of 75° electrical angle where the absolute current value of the U-phase, which is the high heat dissipation phase, is maximum.

At this time, the absolute values of the U-phase current Iu and W-phase current Iw become equal at an electrical angle of 105°, which is an adjustment of 30° electrical angle from the position before adjustment. Therefore, in a section from electrical angle 105° to electrical angle 75° indicated by the thick line, the absolute current value of the U-phase, which is the high heat dissipation phase, is the largest among the three phases. In other words, the rotation stop position is adjusted so as to bias the current to the high heat dissipation phase. In particular, when the rotation stop position is adjusted to a position of an electrical angle 75°, the absolute value of the current in the high heat dissipation phase becomes maximum.

FIG. 10 shows, as a simple example of a configuration, the thermal bias of each phase in a three-phase motor having a stator with three slots every 120°. In the figure, “cold” means a high heat dissipation phase with relatively high heat dissipation, and “hot” means a low heat dissipation phase with relatively low heat dissipation. A circumferential range corresponding to the high heat dissipation phase is indicated by a solid double-headed arrow, and a circumferential range corresponding to the low heat dissipation phase is indicated by a dashed double-headed arrow. When the U phase is a high heat dissipation phase, and the V phase and W phase are low heat dissipation phases, a large current is passed through the W phase, which is a low heat dissipation phase, before adjustment during the lock current application. In the comparative example, the state before the adjustment continues, and heat is unevenly generated in the elements of the inverter 55 and the windings of the motor 60 in the low heat dissipation phase. In contrast, in the stop position adjustment process of the present embodiment, the stop position is adjusted so that the current is biased toward the U-phase, which is a high heat dissipation phase.

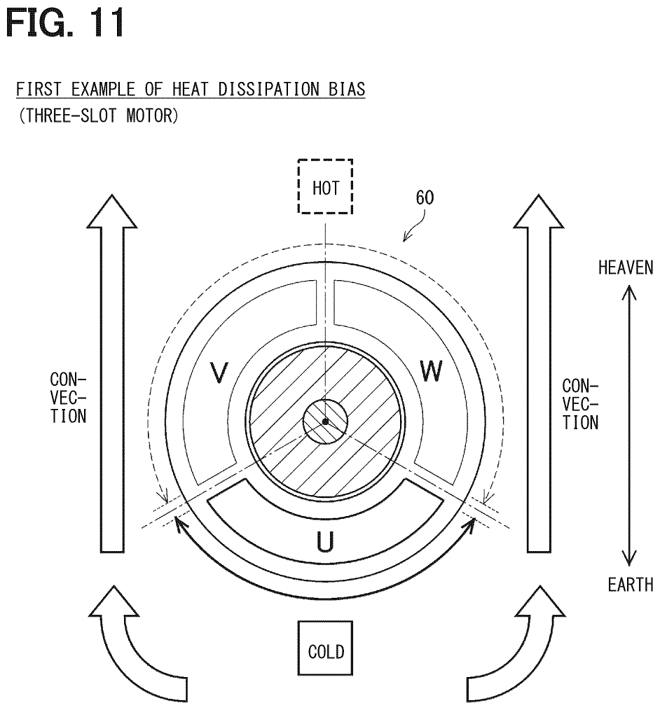

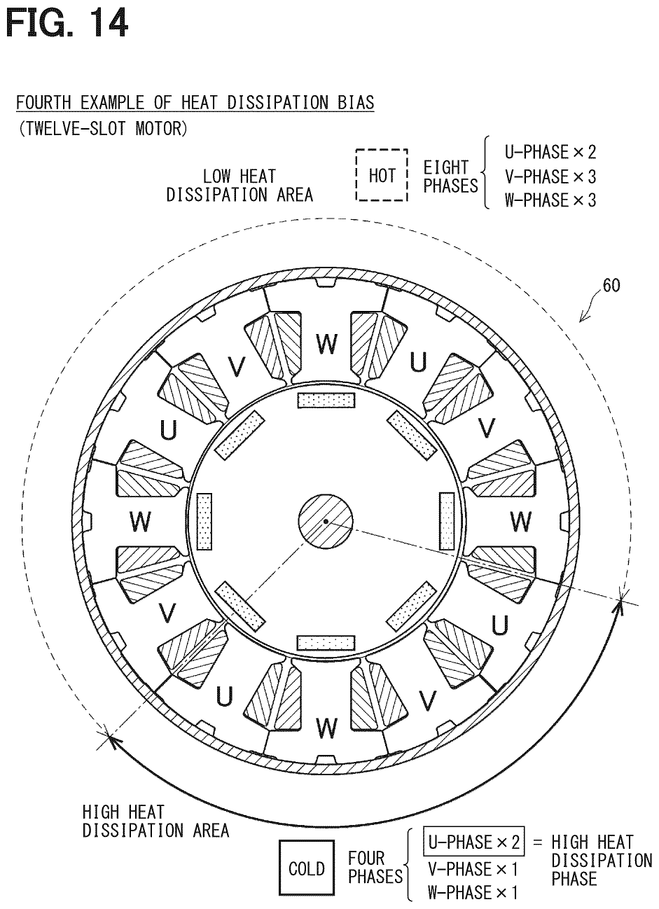

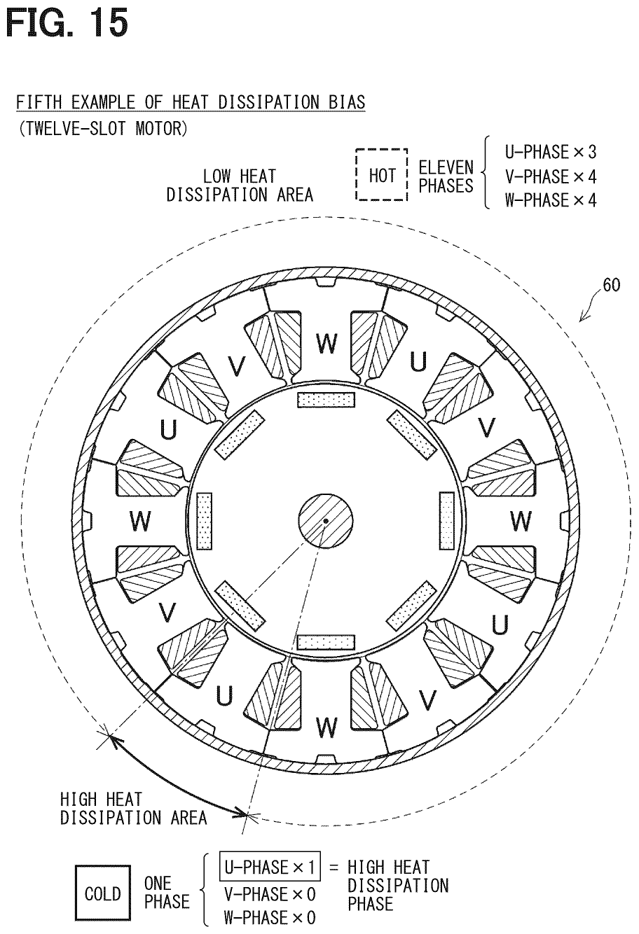

Next, with reference to FIGS. 11 to 15, an example of a heat dissipation imbalance occurring in the motor 60 assembled to the electric brakes 81 to 84 due to the layout, arrangement of peripheral parts, and the like will be described. For convenience, in all examples, the U-phase is considered as the high heat dissipation phase. FIGS. 11 to 13B show some examples of the three-slot three-phase motor similar to that shown in FIG. 10. FIGS. 14 and 15 show an example of a twelve-slot motor in which four sets of three-phase windings are arranged in the circumferential direction.

In the example shown in FIG. 11, the U-phase, which is disposed relatively lower in the vertical direction and has a large cooling effect due to a convection, is the high heat dissipation phase.

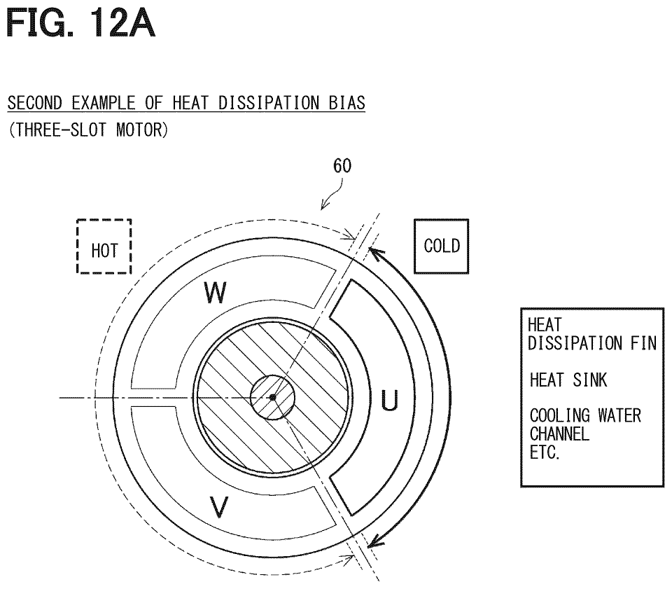

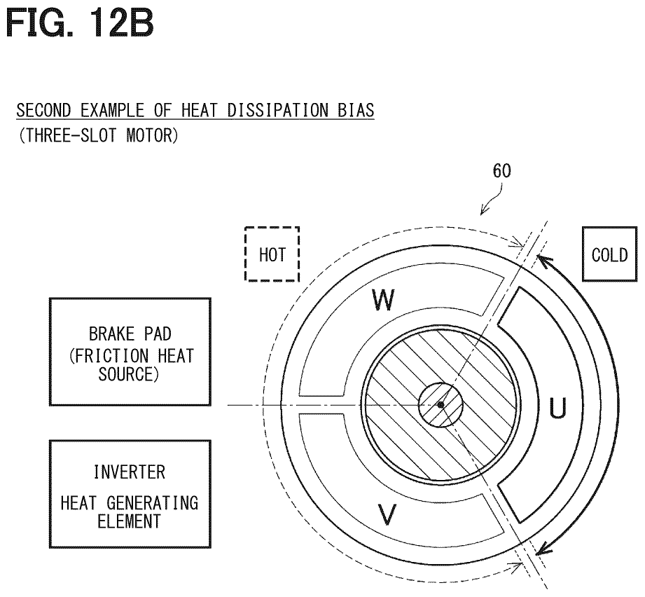

In the example shown in FIG. 12A, the U-phase on the side where heat dissipation fins, a heat sink, a cooling water channels, etc. are installed is the high heat dissipation phase. The heat sink is not limited to a dedicated component, but also includes a component with a large heat capacity that can be received and a portion of a thick housing. Ideally, such a cooling structure should be installed around the entire periphery of the case of the motor 60. However, because there are some parts where such a heater cannot be installed due to structural reasons or because it would be costly, the heater is installed only partially, which can result in uneven heat dissipation.

In the example shown in FIG. 12B, the phases in the vicinity of the brake pads 87, which become a source of frictional heat during braking, and in the vicinity of the heat generating elements of the inverter 55, are low heat dissipation phases, because heat is easily transferred thereto. The U-phase away from these heat sources becomes the high heat dissipation phase.

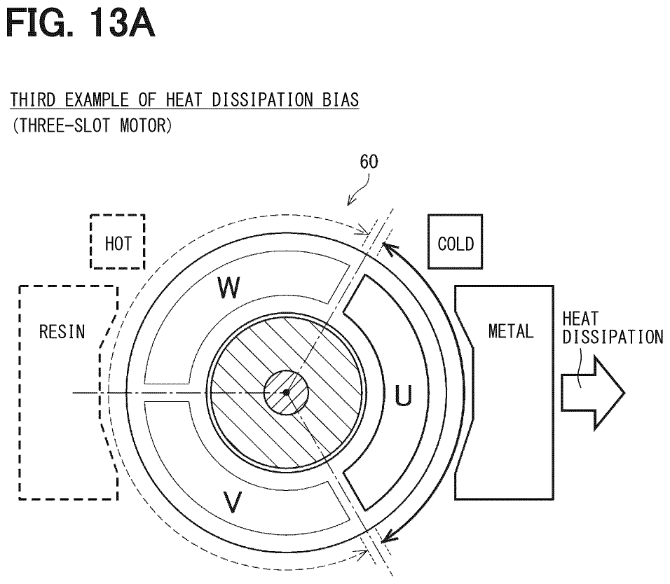

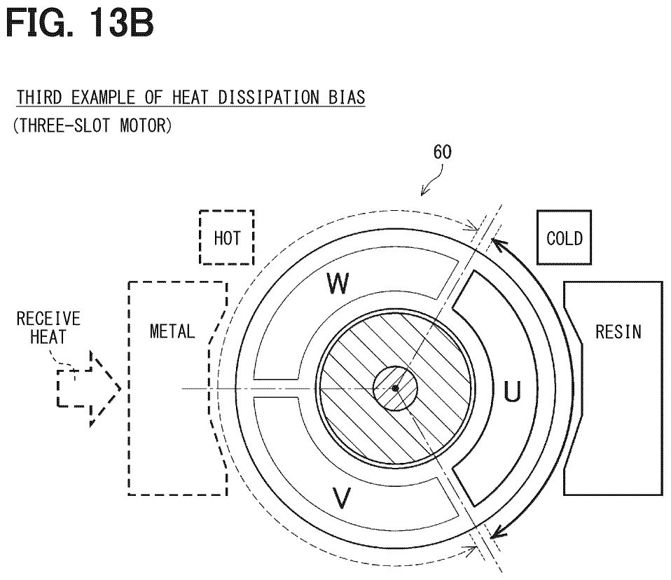

In the examples shown in FIGS. 13A and 13B, the material of the outer periphery of the motor is not uniform, but is a mixture of resin and metal. As shown in FIG. 13A, when heat is dissipated from metal to the outside air, the U-phase, which is arranged on the metal side and has good thermal conductivity, becomes the high heat dissipation phase. As shown in FIG. 13B, when the metal portion receives heat from a heat source present on the other side of the metal portion, conversely, the U-phase arranged on the resin side becomes the high heat dissipation phase.

As shown in FIGS. 14 and 15, in a twelve-slot motor, a total of twelve phases corresponding to each slot are divided into phases included in the high heat dissipation area and phases included in the low heat dissipation area, and the phase most frequently included in the low heat dissipation area is selected as the high heat dissipation phase. In the example shown in FIG. 14, the four phases in the low heat dissipation area include two U-phases, one V-phase and one W-phase, and the U-phase is selected as the high heat dissipation phase. In the example shown in FIG. 15, an area corresponding to one slot with the best heat dissipation performance is the high heat dissipation area, and one phase of the high heat dissipation area (U-phase in this case) is selected as the high heat dissipation phase.

As described above, the high heat dissipation phase may be stored as default information based on the layout of each phase in the motor 60. Alternatively, the high heat dissipation phase may be identified at any time by actually detecting the heat distribution near each phase.

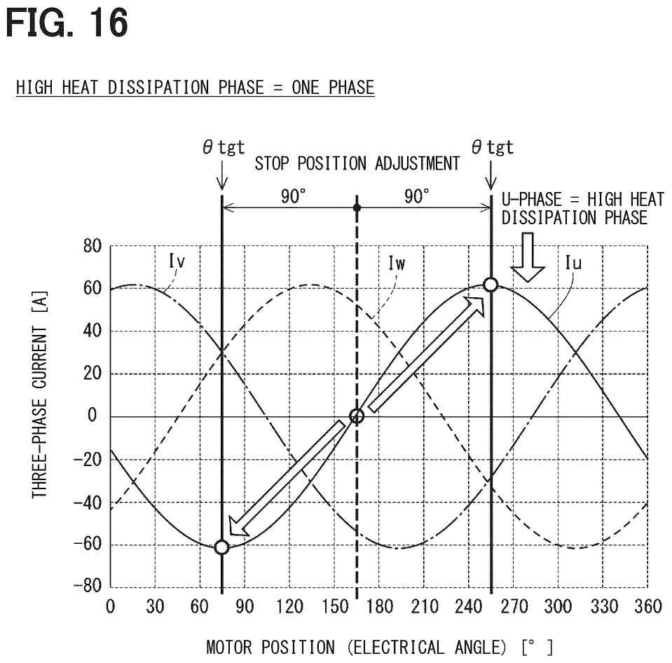

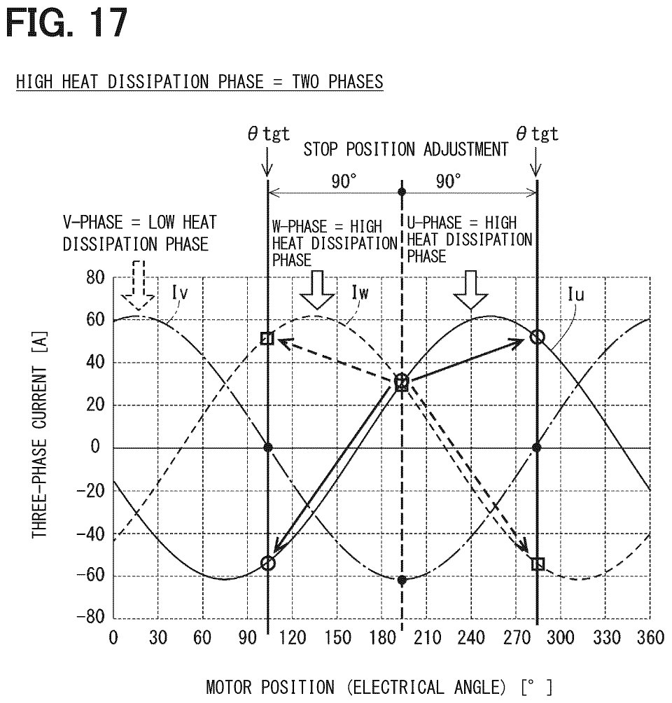

Next, an embodiment of the stop position adjustment process will be described with reference to FIGS. 16 and 17. FIG. 16 shows an example in which the high heat dissipation phase is a single U-phase, and FIG. 17 shows an example in which the high heat dissipation phase is two phases including the U-phase and the W-phase.

As shown in FIG. 16, when there is one high heat dissipation phase, the position where the current absolute value of the high heat dissipation phase is maximum is the target position θtgt. When adjusting from the position of electrical angle 165° where the U-phase current Iu before adjustment is 0 to the target position θtgt of electrical angle 75° or 255° where the absolute value of the U-phase current Iu is maximum, the adjustment amount is an electrical angle of ±90°. Therefore, the position adjustment range from any stop position is set within an electrical angle of ±90°.

As shown in FIG. 17, when there are two high heat dissipation phases, the target position θtgt is the position where the currents Iu, Iw of the U-phase and W-phase, which are the two high heat dissipation phases, have opposite signs and equal absolute values, and the current Iv of the V-phase, which is the low heat dissipation phase, is zero. When adjusting from the position of electrical angle 195° where the currents Iu, Iw of the U-phase and W-phase before the adjustment have the same sign and equal absolute values and where the absolute value of the current Iv of the V-phase is maximum, to the target position θtgt of electrical angle 105° or 285°, the adjustment amount is an electrical angle of ±90°. Therefore, the position adjustment range from any stop position is set within an electrical angle of ±90°.

Here, in order to minimize the load change ΔF that accompanies the adjustment of the stop position, it is preferable that the adjustment amount be set to a minimum. Therefore, it is preferable that the position adjustment is performed in a direction from the stop position before adjustment toward the closest target position θtgt.

For example, the stop position adjuster 67 may store the relationship between the actual position θ before adjustment and the target position θtgt as a map, or in the case of a three-phase motor, may adjust the position so that the remainder when the actual position θ is divided by 60° becomes a specific value. Further, the stop position adjuster 67 may store a map of loads corresponding to the target position θtgt, rather than directly adjusting the position, and adjust the actual load F so that it falls within an appropriate range.

In this manner, in the stop position adjustment process, when the high heat dissipation phase is one phase, for example, the rotation stop position of the motor 60 is preferably adjusted to the target position θtgt where the current absolute value of the high heat dissipation phase is maximum. However, there are cases where the position adjustment range, which is limited based on the allowable fluctuation range of the required load, becomes smaller than the electrical angle of ±90°. In this case, the rotation stop position of the motor 60 is adjusted to a position where the absolute current value of the high heat dissipation phase is maximum within the position adjustment range, that is, the position closest to the target position θtgt within the position adjustment range.

Furthermore, for example, the current command calculation unit 50 may perform a phase adjustment process to change the phase of the current command values Id* and Iq* over time, ensuring that the current phase of the d-axis and q-axis current command values Id and Iq* in the dq coordinate system flow at the same current phase does not continue for more than a predetermined time. This phase adjustment process may be used in combination with the stop position adjustment process of the present embodiment. This is particularly effective when the position cannot be adjusted to the target position θtgt due to limitations in the position adjustment range.

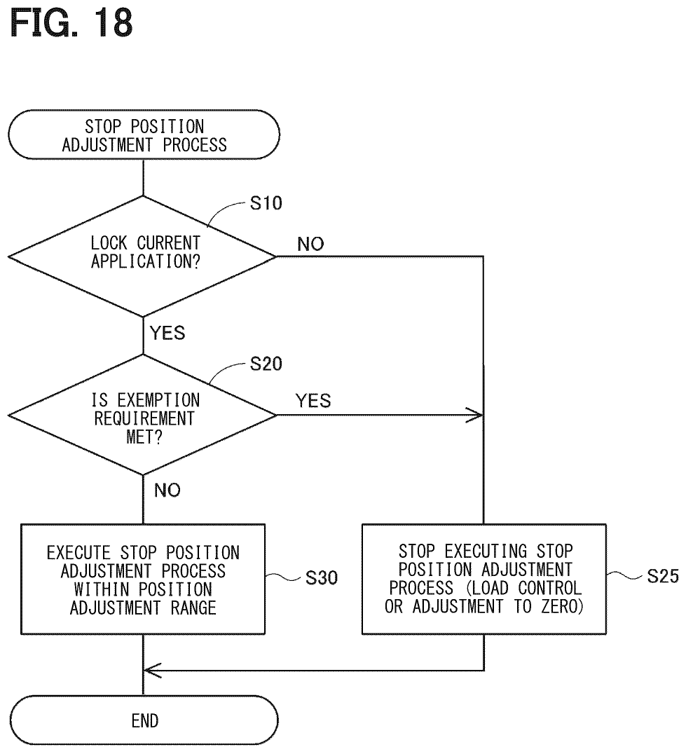

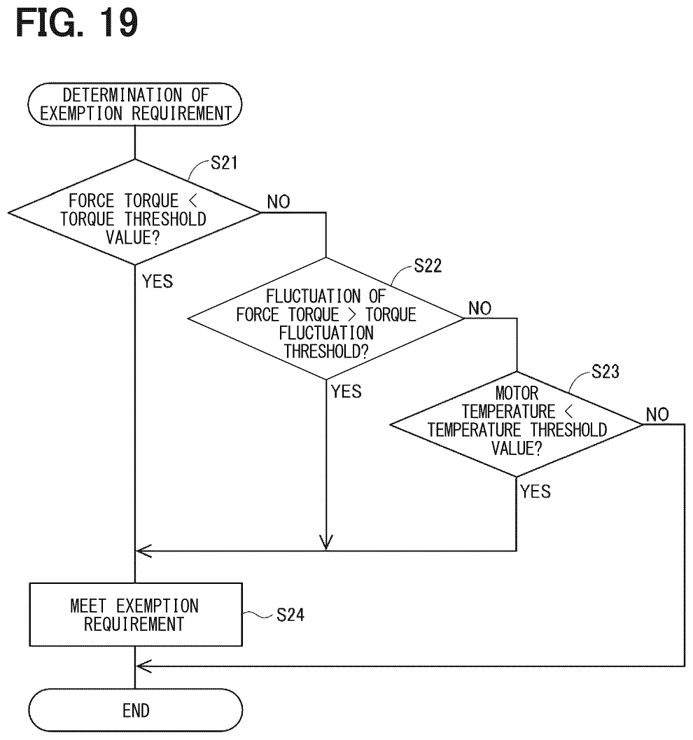

The stop position adjustment process by the stop position adjuster 67 will be described with reference to the flowchart of FIG. 18. In the following flowchart, a symbol S indicates a step. In S10, the stop position adjuster 67 determines whether or not the lock current application is in progress based on the presence or absence of the input of the lock current application signal. When YES is determined in S10, the stop position adjuster 67 determines in S20 whether the exemption requirement is met. A specific example of the exemption requirement will be described later with reference to FIG. 19.

When NO is determined in S20, in S30 the stop position adjuster 67 executes a stop position adjustment process within the phase adjustment range. When NO is determined in S10 or YES is determined in S20, the stop position adjuster 67 stops executing the stop position adjustment process in S25. For example, the switch 48 may switch from a position control to a load control, or the stop position adjuster 67 may execute a position control with the adjustment amount set to zero.

### Exemption

In the present embodiment, the stop position adjuster 67 does not necessarily always execute the stop position adjustment process, and in a situation where heat generation in a specific phase does not become a problem even if lock current is applied, there is no need to execute the stop position adjustment process. Therefore, when a predetermined exemption requirement is met, the stop position adjuster 67 does not execute the stop position adjustment process.

FIG. 19 is a flowchart showing an example of determining whether or not an exemption requirement is satisfied. In this example, whether three exemption requirements are satisfied is sequentially determined in steps S21 to S23. It is determined that the exemption requirement is satisfied in step 24 when it is determined as YES in at least one of steps S21 to S23.

The motor control devices 351 to 354 acquire the load torques TL1 to TL4 or the motor temperatures Temp1 to Temp4 of the respective motors 60. In S21, it is determined whether the load torques TL1 to TL4 of the motor 60 are less than a predetermined torque threshold value. In a low load region, the current that flows when the lock current is applied is small, so the heat generation does not cause an undesirable situation.

In S22, it is determined whether the fluctuation in the load torque TL1 to TL4 of the motor 60 is greater than a predetermined torque fluctuation threshold value. When the affirmative determination (YES) is made in S22, the motor 60 rotates so that the lock current application state is not established in the first place. In S23, it is determined whether the temperatures Temp1 to Temp4 of the motor 60 are less than a predetermined temperature threshold. Even if the lock current is applied, when there is a sufficient margin for the allowable upper limit temperature, there is no need to perform the stop position adjustment process.

In this way, in a case where the lock current is not applied in the first place, or where heat generation in a specific phase does not become a problem even if the lock current is applied, the stop position adjuster 67 does not execute the stop position adjustment process. This makes it possible to prevent unnecessary load change AF caused by the position adjustment.

### Mediation of Stop Position Adjustment Process

When the motor control devices 351 to 354 perform the stop position adjustment process individually for each electric brake 81 to 84, the combination of position adjustment directions in each motor control device 351 to 354 may be inappropriate from the standpoint of braking force balance for the entire vehicle. Therefore, the vehicle brake device 30 mediates the stop position adjustment process of each of the motor control devices 351 to 354. The motor control devices 351 to 354 may communicate information with each other as shown in FIG. 1, or a mediation unit that controls the motor control devices 351 to 354 may be provided separately.

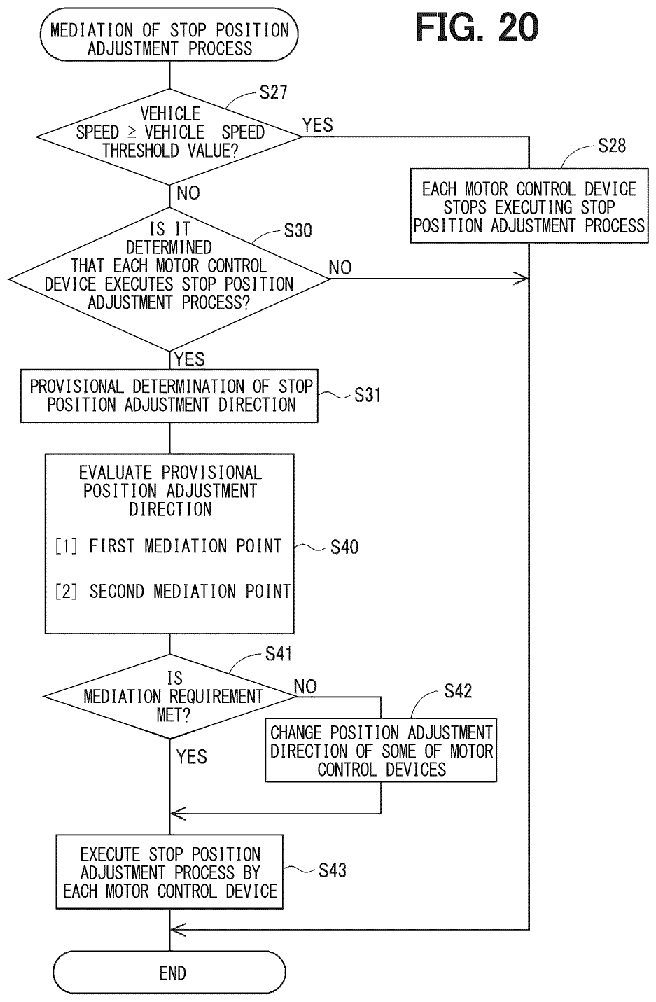

The mediation of the stop position adjustment process will be described with reference to the flowchart of FIG. 20. In S27, it is determined whether the vehicle speed V is equal to or greater than a vehicle speed threshold value as the exemption requirement for the entire vehicle. When Yes is determined in S27, in S28, each of the motor control devices 351 to 354 stops executing the stop position adjustment process.

When NO is determined in S27, in S30, it is determined whether or not it has been determined that the stop position adjustment process is to be executed in each of the motor control devices 351 to 354. When YES is determined in S30, in S31, each of the motor control devices 351 to 354 provisionally determines the position adjustment direction. At this stage, the stop position adjustment process has not yet been executed.

The vehicle brake device 30 mediates the stop position adjustment processes performed by each of the motor control devices 351 to 354 at the following points. At the first mediation point, the vehicle brake device 30 mediates the stop position adjustment processes for each pair of left and right wheels so that the directions of increase or decrease in the braking forces caused by the stop position adjustment processes of the multiple motor control devices 351 to 354 are consistent. This makes it possible to prevent the vehicle 900 from yaw or spinning, while also suppressing uneven heating during lock current application.

At the second mediation point, the vehicle brake device 30 mediates the stop position adjustment processes for the multiple wheels so that the increases or decreases in the braking forces caused by the stop position adjustment processes of the multiple motor control devices 351 to 354 cancel each other out. This makes it possible to minimize the change in actual braking force relative to the required braking force for the entire vehicle.

When trying to achieve a compatibility with the first mediation point, pairs of left and right wheels are excluded from the “multiple wheels” that are the target of mediation. In other words, regarding the multiple wheels arranged in the front-rear direction, the increase and decrease directions of the braking forces are mediated so as to cancel each other out. On the other hand, when yaw or spin may occur and the compatibility with the first arbitration point is not required, the target of the “multiple wheels” in which the increase and decrease directions of the braking force is mediated so as to cancel each other out may include a pair of left and right wheels.

Specifically, in S40, the vehicle brake device 30 evaluates the provisionally determined position adjustment direction. As for the first mediation point, it is evaluated whether the position adjustment directions of the motor control devices 351, 352 corresponding to the left front wheel 91 and the right front wheel 92 are consistent, and whether the position adjustment directions of the motor control devices 353, 354 corresponding to the left rear wheel 93 and the right rear wheel 94 are consistent. As for the second mediation point, it is evaluated whether, for example, the position adjustment directions of the motor control devices 351, 353 corresponding to the left front wheel 91 and the left rear wheel 93 cancel each other out, or whether the position adjustment directions of the motor control devices 352, 354 corresponding to the right front wheel 92 and the right rear wheel 94 cancel each other out.

In S41, it is determined whether these mediation conditions are met. When NO is determined in S41, the position adjustment direction of some of the motor control devices is changed in S42. Here, details such as which motor control device should give priority to the provisionally determined position adjustment direction may be appropriately determined. When YES is determined in S41, or after the position adjustment direction is changed in S42, in S43, each of the motor control devices 351 to 354 executes the stop position adjustment process.

In this manner, the vehicle brake device 30 includes a plurality of motor control devices 351 to 354 that control energization of the motor 60 in each electric brake, and mediates the stop position adjustment processes by the plurality of motor control devices 351 to 354. This makes it possible to prevent the occurrence of yaw or spin, and minimize the change in actual braking force relative to the required braking force for the entire vehicle.

### Second Embodiment

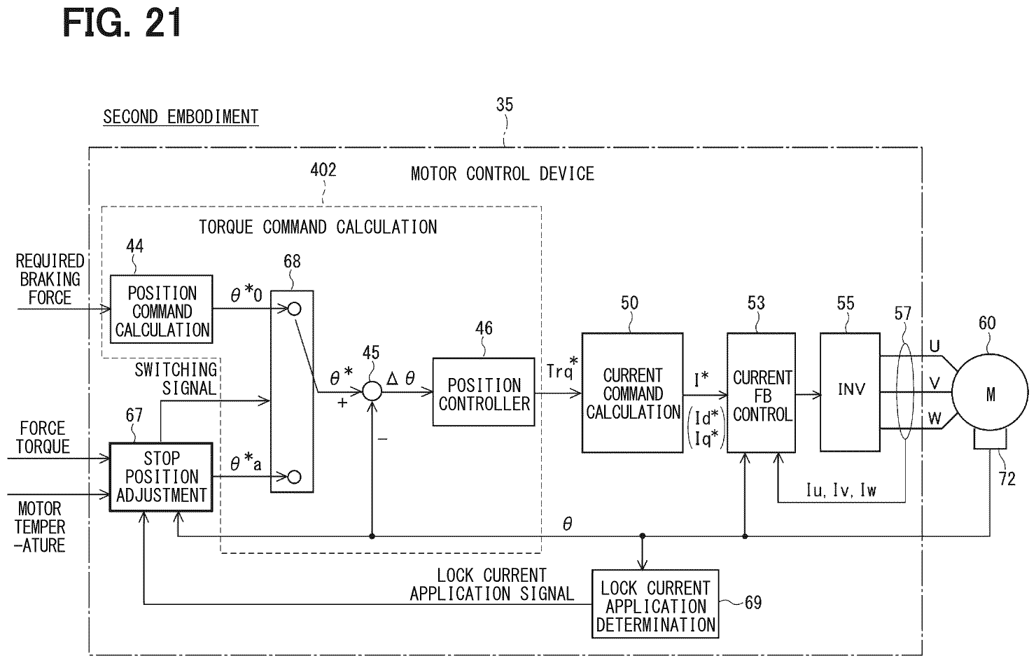

FIG. 21 shows a block diagram of a motor control device according to a second embodiment. Components substantially the same as those in the first embodiment shown in FIG. 5 are denoted by the same reference numerals, and the description thereof will be omitted. The torque command calculation unit 402 of the second embodiment executes a position control based on the actual position θ detected by the position sensor 72 throughout the entire process of increasing, maintaining, and decreasing the braking force. The torque command calculation unit 402 includes a position command calculation unit 44, a position deviation calculator 45, a position controller 46, and a switch 68. The position command calculation unit 44 calculates a basic position command value 0*0 based on the required braking force.

As in the first embodiment, the motor control device 35 includes the lock current application determination unit 69 and the stop position adjuster 67. When it is determined that the “stop position adjustment process” is to be executed, the stop position adjuster 67 calculates an adjusted position command value θ*a and outputs a switching signal to the switch 68. The switch 68 receives a basic position command value θ*0 calculated by the position command calculation unit 44 and the adjusted position command value θ*a calculated by the stop position adjuster 67.

The switch 68 is switched to select the basic position command value θ*0 when the stop position adjustment process is not executed, and to select the adjusted position command value θ*a when the stop position adjustment process is executed. The position command value θ* selected by the switch 68 is input to the position deviation calculator 45. The position deviation calculator 45 and the position controller 46 have the same configuration as those shown in FIG. 5.

In the motor control device of the second embodiment, the specific configuration and effects of the stop position adjustment process are the same as those of the first embodiment, and it is possible to prevent heat generation from being concentrated in a specific phase when the lock current is applied to the motor 60.

### Other Embodiments

The vehicle on which the vehicle brake device of the present disclosure is mounted is not limited to a four-wheel vehicle having two rows of left and right wheels in the vehicle front-rear direction, and may be a vehicle having six or more wheels having three or more rows of wheels in the vehicle front-rear direction. For example, when there is a need to suppress yaw or spin in a six-wheel vehicle, in mediating the stop position adjustment process by the vehicle brake device 30, it is preferable to align the direction of increase and decrease in braking force not only for the front and rear wheels, but also for the pair of left and right wheels in the middle row.

In the motor control device 35 of the first and second embodiments, in the stop position adjustment process, the torque command calculation units 401, 402 calculate the torque command value Trq* that reflects the adjusted rotation stop position. In another embodiment, in the stop position adjustment process, the current command calculation unit 50 may calculate a current command value I* that reflects the adjusted rotation stop position.

In the above embodiment, it is assumed that the angle sensor 72 of the motor 60 is mainly used as the position sensor. However, the stroke sensor 73 of the linear motion mechanism 85 may be used as the position sensor. In this case, the position controller 46 calculates the torque command value so as to bring the position deviation ΔX closer to zero, that is, so as to bring the actual position X closer to the position command value X*. The position adjustment range of the stop position adjustment process is set by the rotation angle converted from the stroke in the same manner as in the above embodiments.

The present disclosure should not be limited to the embodiment described above. Various other embodiments may be implemented without departing from the scope of the present disclosure.

The disclosure of “a motor control device in which the position adjustment range of the stop position adjustment process is set within an electrical angle of ±90°” and “when the multiphase motor is a three-phase motor, and two of the three phases are the high heat dissipation phases, and the other phase is a low heat dissipation phase with relatively low heat dissipation, in the stop position adjustment process, the rotation stop position of the multiphase motor is adjusted to a position where the currents of the two high heat dissipation phases have opposite signs and equal absolute values, and the current of the low heat dissipation phase is zero” may be combined with the disclosure of “a motor control device, in which, when the high heat dissipation phase is one phase, in the stop position adjustment process, the rotation stop position of the multi-phase motor is adjusted to a position where the absolute current value of the high heat dissipation phase is maximum within the position adjustment range”.

The disclosure of “a motor control device applied to a system in which the load acting on a force changes depending on the rotation stop position of the multiphase motor when the lock current is applied, and in the stop position adjustment process, the rotation stop position of the multiphase motor is adjusted to a range corresponding to the allowable fluctuation range of a required load, which is a target value of the load acting on the force” may be combined with each of the disclosures about the motor control device above.

The disclosure of “A motor control device, wherein when at least one of the following requirements for exemption is satisfied: a load torque of the multiphase motor is less than a predetermined torque threshold value; a fluctuation in load torque of the multiphase motor is greater than a predetermined torque fluctuation threshold value; and a temperature of the multiphase motor is less than a predetermined temperature threshold value, the stop position adjuster stops execution of the stop position adjustment process” may be combined with each of the disclosures about the motor control device above.

The disclosure of “A vehicle brake device, wherein, as the exemption condition, when the vehicle speed is equal to or greater than a vehicle speed threshold value, the stop position adjusters of the plurality of motor control devices stop the execution of the stop position adjustment process” may be combined with each of the disclosure of “A vehicle brake device that mediates the stop position adjustment process so that, for each pair of left and right wheels, the directions of increase or decrease in braking force caused by the stop position adjustment process of the plurality of motor control devices coincide” or the disclosure of “A vehicle brake device that mediates the stop position adjustment process so that, for a plurality of wheels, the directions of increase or decrease in braking force caused by the stop position adjustment process of the plurality of motor control devices cancel each other out”.

The motor control device and the technique according to the present disclosure may be achieved by a dedicated computer provided by constituting a processor and a memory programmed to execute one or more functions embodied by a computer program. Alternatively, the motor control device and the technique according to the present disclosure may be achieved by a dedicated computer provided by constituting a processor with one or more dedicated hardware logic circuits. Alternatively, the more control device and the technique according to the present disclosure may be achieved using one or more dedicated computers constituted by a combination of the processor and the memory programmed to execute one or more functions and the processor with one or more hardware logic circuits. The computer programs may be stored, as instructions to be executed by a computer, in a tangible non-transitory computer-readable medium.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A motor control device, comprising:
a torque command calculation unit configured to calculate a torque command value for a multiphase motor;
a current command calculation unit configured to calculate a current command value to be applied to the multiphase motor based on the torque command value;
a power converter configured to convert input power and supplies AC power corresponding to the current command value to the multiphase motor; and
a stop position adjuster configured to execute a stop position adjustment process that adjusts a rotation stop position within a specified position adjustment range when a lock current is applied while a rotation of the multiphase motor is stopped, except in cases where specified exemption requirement is met,
wherein
in the stop position adjustment process, the stop position adjuster adjusts the rotation stop position so as to bias the current to one or more high heat dissipation phases having a relatively high heat dissipation property among phases, and
the torque command calculation unit or the current command calculation unit calculates the torque command value or the current command value that reflects an adjusted rotation stop position.

2. The motor control device according to claim 1, wherein
when the high heat dissipation phase is one phase,
in the stop position adjustment process,
the rotation stop position of the multiphase motor is adjusted to a position where an absolute value of the current of the high heat dissipation phase is maximum within the position adjustment range.

3. The motor control device according to claim 1, wherein
the position adjustment range of the stop position adjustment process is set within an electrical angle of ±90°.

4. The motor control device according to claim 1, wherein
the multiphase motor is a three-phase motor, two of the three phases are the high heat dissipation phases, and one phase other than the high heat dissipation phase is a low heat dissipation phase having a relatively low heat dissipation property,
in the stop position adjustment process,
the rotation stop position of the multiphase motor is adjusted to a position where the currents of the two high heat dissipation phases have opposite signs and equal absolute values, and the current of the low heat dissipation phase becomes zero.

5. The motor control device according to claim 1, wherein
the motor control device is applied to a system in which a load acting on a force changes depending on a rotation stop position of the multiphase motor when a lock current is applied, and
in the stop position adjustment process,
the rotation stop position of the multiphase motor is adjusted to a range corresponding to an allowable fluctuation range of a required load, which is a target value of the load acting on the force.

6. The motor control device according to claim 1, wherein
as an exemption requirement,
when at least one of following exemption requirements is satisfied: a load torque of the multiphase motor is less than a predetermined torque threshold; a variation in the load torque of the multiphase motor is larger than a predetermined torque variation threshold value; and a temperature of the multiphase motor is less than a predetermined temperature threshold value,
the stop position adjuster stops an execution of the stop position adjustment process.

7. A vehicle brake device which is mounted on a four or more wheel vehicle including two or more rows of left and right wheels in a front-rear direction, converts torque output by a polyphase motor into linear force by a linear motion mechanism, and applies pressure to a corresponding wheel to generate a braking force to brake the vehicle by a plurality of electric brakes, the vehicle brake device, comprising:
a motor control device according to claim 1, which controls energization of the multiphase motor in each of the electric brakes, wherein
the vehicle brake device mediates stop position adjustment processes performed by a plurality of motor control devices.

8. The vehicle brake device according to claim 7, wherein
the vehicle brake device mediates the stop position adjustment processes for each pair of left and right wheels so that a direction of increase or decrease in braking force caused by the stop position adjustment processes of the multiple motor control devices are consistent.

9. The vehicle brake device according to claim 7, wherein
the vehicle brake device mediates the stop position adjustment processes for a plurality of wheels so that a direction of increase or decrease in braking force caused by the stop position adjustment processes of the plurality of motor control devices cancel each other out.

10. The vehicle brake device according to claim 7, wherein
as an exemption condition, when a vehicle speed is equal to or greater than a vehicle speed threshold value, the stop position adjusters of the plurality of motor control devices stop executing the stop position adjustment process.

11. A motor control device, comprising:
a computer including a processor and a memory that stores instructions configured to, when executed by the processor, cause the processor to
calculate a torque command value for a multiphase motor,
calculate a current command value to be applied to the multiphase motor based on the torque command value,
convert input power and supplies AC power corresponding to the current command value to the multiphase motor, and
execute a stop position adjustment process that adjusts a rotation stop position within a specified position adjustment range when a lock current is applied while a rotation of the multiphase motor is stopped, except in cases where specified exemption requirement is met,
wherein
the computer causes the processor to
in the stop position adjustment process, adjust the rotation stop position so as to bias the current to one or more high heat dissipation phases having a relatively high heat dissipation property among phases, and
calculate the torque command value or the current command value that reflects an adjusted rotation stop position.

12. The motor control device according to claim 11, wherein
when the high heat dissipation phase is one phase,
the computer causes the processor to
in the stop position adjustment process,
adjust the rotation stop position of the multiphase motor to a position where an absolute value of the current of the high heat dissipation phase is maximum within the position adjustment range.

13. The motor control device according to claim 11, wherein
the position adjustment range of the stop position adjustment process is set within an electrical angle of ±90°.

14. The motor control device according to claim 11, wherein
the multiphase motor is a three-phase motor, two of the three phases are the high heat dissipation phases, and one phase other than the high heat dissipation phase is a low heat dissipation phase having a relatively low heat dissipation property,
the computer causes the processor to
in the stop position adjustment process,
adjust the rotation stop position of the multiphase motor to a position where the currents of the two high heat dissipation phases have opposite signs and equal absolute values, and the current of the low heat dissipation phase becomes zero.

15. The motor control device according to claim 11, wherein
the motor control device is applied to a system in which a load acting on a force changes depending on a rotation stop position of the multiphase motor when a lock current is applied, and
the computer causes the processor to
in the stop position adjustment process,
adjust the rotation stop position of the multiphase motor to a range corresponding to an allowable fluctuation range of a required load, which is a target value of the load acting on the force.

16. The motor control device according to claim 11, wherein
as an exemption requirement,
when at least one of following exemption requirements is satisfied: a load torque of the multiphase motor is less than a predetermined torque threshold; a variation in the load torque of the multiphase motor is larger than a predetermined torque variation threshold value; and a temperature of the multiphase motor is less than a predetermined temperature threshold value,
the computer causes the processor to stop an execution of the stop position adjustment process.
